(19) United States
(12) Patent Application Publication
(10) Pub. No.: US 2006/0179595 A1
(43) Pub. Date: Aug. 17, 2006

(54) Corner painting tool

(76) Inventors: Craig S. Serio, New Berlin, WI (US); Michael M. Potempa, Oak Creek, WI (US); Brian S. Potempa, Oak Creek, WI (US); Matthew G. Goulet, Milwaukee, WI (US)

Correspondence Address: TAFT, STETTINIUS & HOLLISTER LLP, SUITE 1800, 425 WALNUT STREET, CINCINNATI, OH, 45202-3957, US

(21) Appl. No.: 11/354,573

(22) Filed: Feb. 15, 2006

Related U.S. Application Data
(63) Continuation of application No. PCT/US03/25828, filed on Aug. 15, 2003.

(51) Int. Cl. B05C 17/00

(52) U.S. Cl. 15/210.1

(57) ABSTRACT

A paint applicator for use in a corner application having a pad pivotally attached to the handle. The head may be resiliently biased as well.

### CROSS-REFERENCE TO RELATED APPLICATIONS

This application is a continuation that claims priority under 35 U.S.C. §120 of Patent Cooperation Treaty International Application No. PCT/US2003/025828 filed on Aug. 15, 2003 entitled “CORNER PAINTING TOOL”, the contents of which are herein incorporated by reference.

### FIELD OF THE DISCLOSURE

The present invention generally relates to paint application devices and more particularly to paint application devices which are adapted for applying paint to corner surfaces.

### BACKGROUND OF THE INVENTION

The use of paint applicators such as paint brushes, paint rollers, and paint pads for the application of paint to walls and the like is well known. Brushes allow for accurate paint application in that they provide a relatively small interface area with respect to the surface being painted and can be provided in a wide array of sizes. However, brushes are relatively slow due to their typical sizes and limited paint holding volume. Moreover, depending on the quality of paint and the diligence of the worker, brushes can often result in visible brush strokes and loose bristles in the dried paint.

Matted rollers are therefore often the tool of choice for fast paint application to relatively large surfaces such as walls and ceilings. The matted material forming the roller is sufficiently absorbent to hold a large volume of paint.

That volume can be further enhanced by tailoring the width and diameter of the roller to the given application. However, given such size and shape, accurate control of the paint application is difficult, and accurate application to corner surfaces is especially problematic.

Foam pads are therefore often the tool of choice given the demands of paint application and drawbacks of the above-referenced alternatives. Such applicators absorb a relatively high volume of paint, and can be dabbed onto intricate textures. Moreover, such pads often have a straight or angular edge enabling application of paint along a straight trim line or to a corner surface and the like.

### BRIEF DESCRIPTION OF THE DRAWINGS

FIG. 1 is a bottom view illustrating a corner painting tool in accordance with the invention;

FIG. 2 is a perspective view illustrating the corner painting tool depicted in FIG. 1;

FIG. 3 is a perspective view illustrating the attachment of a paint pad to the corner painting tool depicted in FIG. 1;

FIG. 4 is a top view illustrating various features of the corner painting tool depicted in FIG. 1 in phantom;

FIG. 5 is a cross-sectional view of the corner painting tool taken along line 5-5 of FIG. 4; and,

FIG. 6 is a side elevational view illustrating the corner painting tool depicted in FIG. 1.

### DETAILED DESCRIPTION OF THE INVENTION

Referring now to the drawings figures, a corner painting tool (also referred to as a corner painting device) constructed in accordance with the teachings of the disclosure is generally referred to by reference numeral 10.

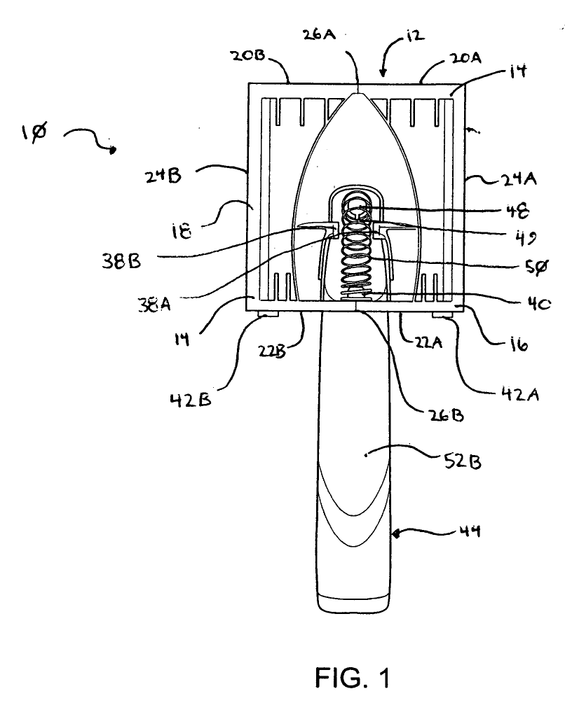

As illustrated in FIG. 1, corner painting tool 10 includes a head 12.

Head 12 provides a pad presenting surface 14, which includes a first front face 16 and a second front face 18. First front face 16 and second front face 18 are generally disposed at right angles to each other such that the faces 16,18 can engage corner surfaces. Faces 16,18 are generally defined by upper edges 20A, 20B, lower edges 22A, 22B, and side edges 24A, 24B. Head 12 also provides corner engaging points 26A, 26B.

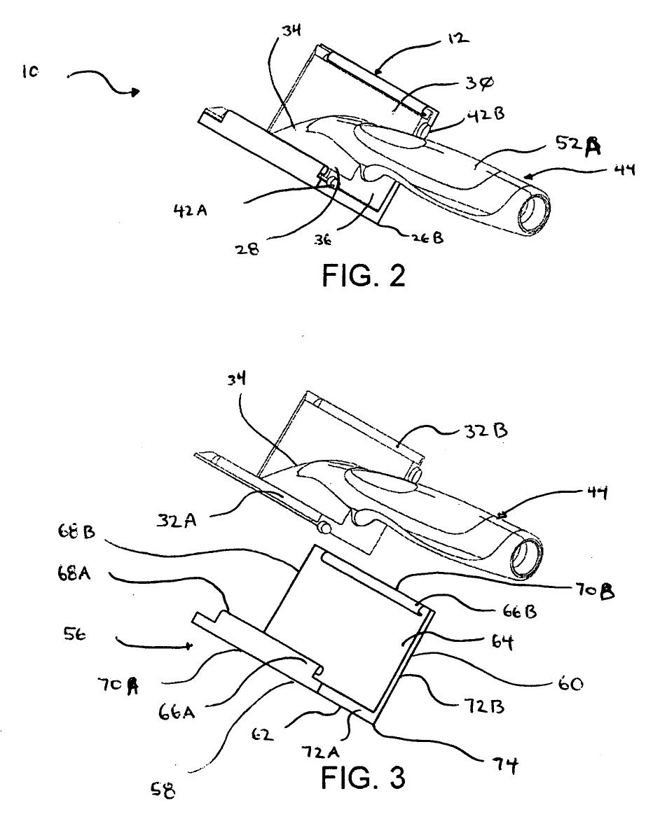

As shown in FIG. 2, head 12 of a corner painting tool 10 in accordance with the invention also comprises a first rear face 28 and a second rear face 30. The rear faces 28,30 include grooves 32A, 32B (FIG. 3). Rear faces 28 and 30 are generally interconnected by a bridge 34 and a top wall 36.

Referring now again to FIG. 1, bridge 34 provides projecting tabs or bosses 38A, 38B. With further reference to both FIGS. 1 and 2, the interior of top wall 36 provides a retention knob 40. Projections 42A and 42B extend from the lower edges 22A, 22B of faces 16,18.

The corner painting tools also generally include a handle 44. With reference to FIG. 5, handle 44 includes recesses 46A, 46B for receiving bosses 38A, 38B. Handle 44 is capable of pivoting about an axle (not shown) defined by the interaction between recesses 46A, 46B and bosses 38A, 38B. Head 12 is capable of rotating between about 0 degrees and about 90 degrees with respect to the handle 44.

In particular, head 12 is capable of rotating at least about 80 degrees with respect to handle 44.

Handle 44 further includes a retention knob 48, which provides a retention tab 49. Retention tab 49 is oriented generally perpendicular to retention knob 48, as illustrated in FIG. 1. In one embodiment of a corner painting device according to the invention, a resilient element 50 is provided between retention knob 40 and retention knob 48. In the illustrated embodiment, resilient element 50 is held in place between retention knob 40 and retention knob 48 by retention tab 49.

Resilient element 50 is exemplified by a spring, but any conventionally known element capable of biasing the head 12 with respect to the handle 44 may be used in accordance with the invention. Springs having a spring constant between about 5 lbs/inch and about 35 pounds/inch may be used including but not limited to springs having a spring constant of about 20 pounds/inch.

Including a resilient element 50 such as a spring to bias head 12 with respect to handle 44 is advantageous for a number of reasons. Resilient element 50 provides steady positive pressure when the corner painting tool is engaged with a surface to be painted, regardless of the orientation of the handle 44 with respect to the head 12. That is, resilient element 50 provides steady positive pressure to the head 12 when the corner painting device 10 is engaged with the painting surface regardless of the angle of the handle 44 as the handle 44 is pivoted about bosses 38A, 38B.

Furthermore, resilient element 50 causes the pad to automatically return to a normal (or neutral) position with respect to the handle and allows controlled paint loading from a comfortable angle. Including a resilient element 50 also makes it easier to initially apply the tool 10 to the wall surface, as the head 12 would otherwise be free to pivot as it was transported from a paint loading container (such as a paint bucket or a paint tray) to a wall surface, thereby increasing the risk of unintentionally splattering or dripping of paint.

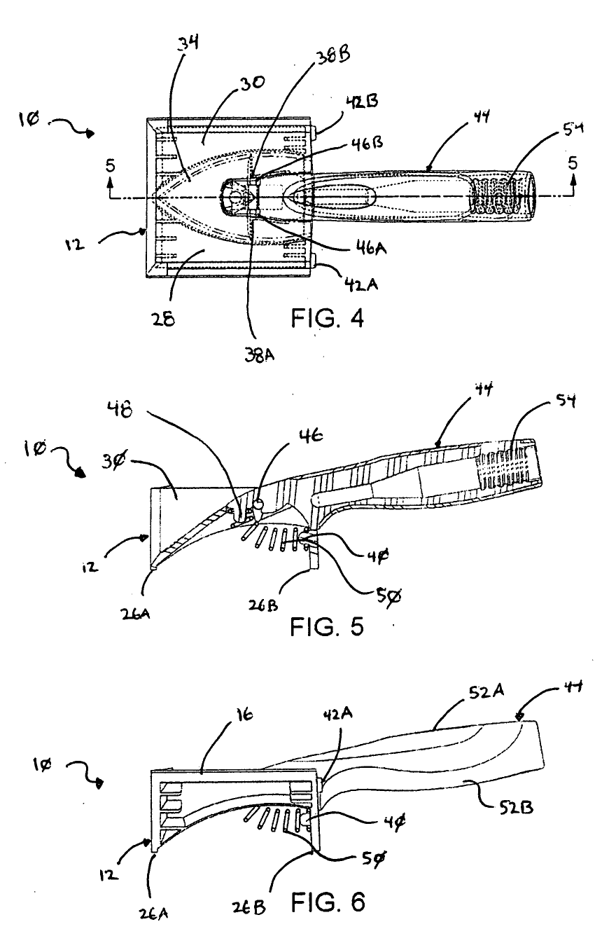

Handle 44 may also include grip portions 52A, 52B. Grip portions 52A, 52B are typically provided by an elastomeric material. Various thermoplastic elastomers, such as Santopreneg products (Advanced Elastomer Systems, L. P., Akron, Ohio), may be used to provide rubbery gripping surfaces on the exterior of handle 44. As shown in FIGS. 4 and 5, handle 44 may be molded to include threads 54 for engaging a conventional extension pole. Of course, corner painting tool 10 may be used without such an extension pole.

As illustrated in FIG. 3, pad 56 is generally angular, and is capable of engaging corner surfaces. Pad 56 includes pad faces 58 and 60. Pad 56 comprises a paint carrying fabric 62, which is adhered to a pad backing 64. A suitable material for the pad fabric is a woven short nylon, having a pile height between about 0.05 inches and about 0.25 inches. A suitable fabric pile height is about 0.18 inches. A suitable material for the pad backing 64 is polyvinyl chloride.

Pad 56 need not be a two component construction, i.e., pad 56 may comprise a single unitary material. Pad 56 also provides retaining elements 66A, 66B for engaging grooves 32A, 32B. Accordingly, retaining elements 66A and 66B may be received by grooves 32A and 32B, in order to effect the coupling of pad 56 to head 12 and retain paid 56 on pad presenting surface 14. Preferably, retaining elements 66A, 66B of pad 56 can engage grooves 32A, 32B by a snap-fit.

Pad 56 is generally defined by top edges 68A, 68B, side edges 70A, 70B, and bottom edges 72A, 72B. Pad 56 also provides a corner engaging edge 74, <BR> <BR> which is capable of engaging a corner surface, i.e., a surface defined by two walls (or similar surfaces) which are connected at right angles. Top edges 68A and 68B are generally linear. In general, each pad face 58,60 is generally rectangularly shaped.

Accordingly, top edges 68A and 68B are generally perpendicular or transverse to side edges 70A and 70B. Similarly, bottom edges 72A and 72B are generally perpendicular to side edges 70A and 70B.

Providing linear top edges 68A, 68B is advantageous because it allows corner painting tool 10 to paint a corner surface all the way up to the ceiling.

Additionally, providing linear top edges 68A, 68B to corner painting tool 10 allows the user to apply paint to either side of the corner along the edge of the ceiling.

Accordingly, corner painting tool 10 allows a user to both paint corners and to edge painting surfaces.

Head 12 and handle 44 may be manufactured through a variety of methods including, without limitation, injection molding, injection stretch blow molding, thermoforming, extrusion blow molding, injection blow molding, insert molding, co-injection molding, rotational molding, and other methods known in the art. Injection molding is the preferred method for manufacture.

A variety of thermoplastic resins may be used to manufacture the handle and head of the corner painting tools of the invention, including polyethylenes (e.g., high density polyethylene or linear low density polyethylene), polypropylenes (including structural foam comprising polypropylene), polyethylene terepthalates, polyvinyl chlorides, polycarbonates, etc. Polypropylenes are preferred materials for head 12 and handle 44 construction.

Although the foregoing text sets forth a detailed description of numerous different embodiments of a container for a paint roller assembly, it should be understood that the detailed description is to be construed as exemplary only and does not describe every possible embodiment of a container for a paint roller assembly. The present invention generally relates to paint applicators and more particularly to paint applicators including a paint application element which has a non-stick coating.

What is claimed is:

1. A corner painting tool comprising:
a head including a first frame and a second frame, the first frame comprising a first rear face and a first front face defining a first plane, and the second frame comprising a second rear face and a second front face defining a second plane, wherein the first plane is substantially perpendicular to the second plane;
a handle pivotally connected to the head; and, a pad removably attached to the head.

2. The corner painting tool according to claim 1, further comprising:
a resilient element for biasing the head toward a normal position with respect to the handle.

3. The corner painting tool according to claim 1, wherein the first and second front faces provide top edges, side edges, and bottom edges, and the top edges are generally perpendicular to the side edges.

4. The corner painting tool according to claim 3, wherein the bottom edges are generally perpendicular to the side edges.

5. The corner painting tool according to claim 1, wherein the first and second rear faces include grooves.

6. The corner painting tool according to claim 5, wherein the pad include retaining elements engageable with the grooves.

7. The corner painting tool according to claim 1, wherein the pad comprises a fabric capable of delivering a liquid medium, the fabric being adhered to a backing material.

8. The corner painting tool according to claim 1, wherein the head and the handle include retention nobs.

9. A corner painting tool comprising:
a head including a first frame and a second frame, the first frame comprising a first rear face and a first front face defining a first plane, and the second frame comprising a second rear face and a second front face defining a second plane, wherein the first plane is substantially perpendicular to the second plane;
a handle pivotally connected to the head; a rectangularly shaped pad for applying a liquid coupled to the head;
wherein the first and second front faces provide top edges, side edges, and bottom edges, and the top edges are generally perpendicular to the side edges.

10. The corner painting tool according to claim 9, wherein the bottom edges are generally perpendicular to the side edges.

11. A corner painting tool comprising:
a head including a first frame and a second frame, the first frame comprising a first rear face and a first front face defining a first plane, and the second frame comprising a second rear face and a second front face defining a second plane, wherein the first plane is substantially perpendicular to the second plane; a handle pivotally connected to the head;
a rectangularly shaped pad for applying a liquid coupled to the head;
and, a resilient element for biasing the head toward a normal position with respect to the handle.
